(19) United States
(12) Patent Application Publication
(10) Pub. No.: US 2008/0304389 A1
(43) Pub. Date: Dec. 11, 2008

(54) Method for Recording Data Having a Distinctive Feature

(75) Inventor: Jacobus Maarten Den Hollander, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,182

(22) PCT Filed: Dec. 8, 2006
(86) PCT No.: PCT/IB2006/054711

§ 371 Date: Jun. 12, 2008

(30) Foreign Application Priority Data
Dec. 15, 2005 (EP) 05112259.6

(51) Int. Cl. G11B 20/10; G11B 20/00

(52) U.S. Cl. 369/59.1; 369/53.21; G9B/20.009

(57) ABSTRACT

In the field of content distribution a typical problem is the protection of Digital Rights information (DRM), which is appended to the content and recorded on a record carrier in the form of a corresponding recorded pattern, from tampering by malicious users. According to some known schemes, the protection is implemented by linking the DRM to some physical distinctive feature of the corresponding recorded pattern. From this distinctive feature fingerprint data can be extracted with some conventional method, and used for the authentication of the DRM. The invention proposes a method of recording data wherein variations in the density of the recorded pattern are formed, as result of a perturbation in the recording process, which is a non-controllable substantially random process.

The invention relates to a method of recording data on a record carrier and to a corresponding apparatus.

The invention further relates to a method of extracting fingerprint data from data recorded on a record carrier and to a corresponding apparatus.

The invention further relates to a record carrier having data recorded thereon.

With the advent of new on-line content distribution channels like iTunes, MusicMatch, PressPlay, Windows-Media Digital Rights Management (DRM) has started to play an increasingly important role. Currently three categories of DRM are employed. They can be distinguished by the way they store and protect the usage rights (such as “copy one time”, “view until Wednesday”, etc.):

1. Network-centric: the rights are stored securely on a dedicated server in a network. Devices wanting to access content consult the server to obtain (and if necessary update) the rights. The server might reside somewhere on the Internet (e.g. at the content owner's), or in a home network. This DRM category requires devices to be (almost) always on-line when accessing content.

2. (Personal) Card-centric: the rights are stored securely on a removable card or token, e.g. a smart-card, SD card, MemoryStick etc. Devices wanting to access content contact the removable security card to obtain (and if necessary update) the rights. This DRM category requires devices to have a slot for a plug-in card.

3. Device-centric: the rights are stored securely inside a fixed playback or storage device (e.g. a PC on which the content resides). A device wanting to access content administers the rights itself. The consequence of this DRM category is that content is always locked to a single device. The MusicMatch—and the original Windows DRM service are examples of such systems.

In the last few years a fourth variant has been developed which aims essentially at marrying the current optical media content distribution business-model to DRM, giving an optical disc almost the same functionality as flash memory cards such as SD-card or MemoryStick:

4. Media-centric: the rights are stored securely on the recordable media itself. Devices wanting to access content have special circuitry to retrieve (and if necessary update) the rights on the media. The consequence of this DRM category is that content can be consumed in any (media-centric DRM compatible) device (rights travel together with the content).

Although the last category looks very appealing from a consumer point of view, technically it is the most complicated one, because the layout of optical media has been standardized giving attackers direct access to all bits and bytes without further need for authentication and knowledge of system secrets etc. Of course, it is well known, e.g. from disc-based copy protection systems (DVD, CD, etc.), how to prevent such bits from being copied, using tools from cryptography (ciphers, key-distribution schemes, broadcast-encryption etc.) and disc-marks/ROM side-channels (wobbles, BCA with unique media ID, . . . ). However none of these systems had to contend with the particularly vicious save-and-restore attack, unique to DRM systems with consumable rights.

Contrary to static rights (copy never, copy free, EPN (encryption plus non-assertion state)), consumable rights are rights which typically get more restrictive every time the content is consumed, e.g. play 4× , or record 3×. The save-and-restore attack goes as follows:
content with corresponding digital rights is purchased and legitimately downloaded onto the storage medium;
the attacker makes a temporary bit-copy of the storage medium (“image”) onto some other storage medium, such as a hard-disc drive (HDD);
the original storage medium is “consumed”, i.e. used normally, which means that the rights decrement in some sense;

at any given moment the attacker can restore the original rights by copying back the image from the alternate storage (HDD). In this process the original rights are restored as well, even if the attacker doesn't know what the (encrypted) bits which have been copied back mean: the medium has simply been returned to its virgin state. This is independent of the use of any ROM side-channels such as the “Disc Mark” (e.g. a unique, but fixed media identifier in the BCA).

A method to resolve this hack is disclosed in WO02/015184 A1. According to this method a hidden channel (HC) as a side-channel is introduced. A side-channel is a method to store additional information on a recording medium by exploiting the fact that multiple read-out signals represent the same user-data pattern (data available to the user). E.g. an additional message may be coded in the error-correction parities. The error-correction mechanism will remove these parities, so the user does not see any difference, but dedicated circuitry preceding the error-correction mechanism does. Of course in this example the information capacity of the medium has been increased at the expense of decreasing the system's error-correcting capacity.

According to WO02/015184 A1 the HC is a side-channel on the storage medium containing information which observes the constraint that it cannot be recorded by the user but only by some compliant DRM application, and is therefore lost in bit-copies. Simple examples are data stored in sector headers and certain parts of the lead-in area. More sophisticated examples are redundancies in the standard for the storage medium, in which information is stored by making a particular choice for such a redundancy, e.g. selecting certain merging bit patterns on CD, or specific trends in the DSV (digital sum value, the running sum of channel-bits) on a DVD as, for instance, described in U.S. Pat. No. 5,828,754, or intentional errors in sector data (which can be corrected by the redundant ECC-symbols). Yet another example is information stored in slow variations of the channel-bit clock as, for instance, described in U.S. Pat. No. 5,737,286.

During the update of rights, the HC is used as follows:
1. when the digital rights are updated (created or overrecorded), a new random data-string is chosen and recorded into the HC;
2. the new values of the digital rights are cryptographically bound to (amongst other things) the data-string recorded into the HC. An example would be constructing a key which depends on the HC-payload, and applying a digital signature to the digital rights with this key; or alternatively to encrypt the digital rights with this key. The signature could be either based on symmetric key cryptography (a so-called Message Authentication Code, or MAC), or public key cryptography (e.g. DSA-, or RSA-based signatures).

During read-out of the rights the following check is performed using the HC:
(i) when the digital rights are read, the data-string is retrieved from the HC;
(ii) the key from step 2 above which depends on the HC data-string is re-created and used to verify the cryptographic relationship between the digital rights and the HC (either check the signature on the digital-rights, or decrypt the digital rights).

Step (ii) prevents the save-and-restore attack: the image, including the original digital rights may be restored by the attacker, but the HC cannot, therefore the check in step (ii) fails. Rights and content keys can be protected in a Key Locker which in turn is protected by a Key Locker Key, which depends (partially) on the payload of a HC. Further, it is not necessary for the data in the HC to be confidential; however, it should be very difficult for the attacker to modify these bits.

However, the system known from WO 02/015184 suffers from a disadvantage: because this known system relies on a universal secret present in every consumer device, viz. the algorithm by which bits are stored in the hidden channel. An attacker could therefore build a non-compliant device which would enable him to get access to the hidden information so that he could manipulate the hidden information, and thus could provide him with illegal access to encrypted content by manipulating any digital rights. It is therefore desired to provide measures which make it very difficult, expensive or even impossible to construct such a device for reasons which do not depend on the presence of a universal secret.

This disadvantage is overcome according to non-prepublished EP application No. 04106504.6 (filed on Dec 13, 2004 by the same applicant), which describes a method for controlling distribution and use of a Digital Work (DW), wherein the DW, along with appended Usage Right Information (URI), specifying the conditions under which the DW can be accessed, is recorded on a record carrier. The described method foresees that:
the URI is recorded on the record carrier,
fingerprint data are extracted from the recorded URI, and
authentication data, derived from the fingerprint data, are also recorded on the record carrier for subsequent authentication of the URI,
so as to prevent that a user can replace the URI with another URI which is less restrictive, without this being detected.

This method relies on extracting the fingerprint data from a pattern recorded on the record carrier. In particular, a distinctive feature of a recorded pattern, known in the art as “fingerprint”, can be represented by channel-bit errors of predetermined data recorded on said record carrier, or from the positions of the zero-crossings of a read-out signal with respect to channel bit boundaries of predetermined data recorded on said record carrier, or from the highest or lowest values, respectively, at a predetermined position of predetermined data recorded on said record carrier.

In other words the “fingerprint” of a recorded pattern is a feature by which the recorded pattern can be distinguished from any other recorded pattern, even when representing the same data. Moreover, the fingerprint is obtained as result of some non-controlled process, in this case is inherent to the recording process, so that it is either impossible or unfeasible to record a pattern having a desired fingerprint.

It is a first object of the present invention to provide a method of recording data on a record carrier, from which data fingerprint data can be extracted in an alternative manner, and a corresponding apparatus.

It is a second object of the present invention to provide an alternative method of extracting fingreprint data from data recorded on a record carrier, and a corresponding apparatus.

It is a third object of the present invention to provide a record carrier having recorded data, from which data fingerprint data can be extracted in an alternative manner.

According to the invention, the first object is achieved by a method of recording data as claimed in claim 1, and by an apparatus for recording data as claimed in claim 8. Therefore, according to the invention the distinctive feature of the recorded pattern from which the fingerprint data is extracted are variations in the channel bit length, i.e. variations in the longitudinal density of the recorded pattern. While according to the above-mentioned non-prepublished EP application No. 04106504.6 the distinctive feature is found in unavoidable differences between recorded patterns, resulting as a side effect of the recording process, in the method according to the present invention instead, the distinctive feature is purposely created. This has the advantage of making more robust and reliable the extraction of the fingerprint data, since the recording process can be adapted to creating a recorded pattern where the distinctive feature is sufficiently easy to detect, i.e. a longitudinal density having sufficiently large variations, or in other words where the distinctive feature can be detected with a sufficiently high signal-to-noise ratio. Yet the distinctive feature is created with an uncontrollable and substantially random process, so that it will be generally not possible to record a pattern with a predetermined fingerprint. The fingerprint data can then be extracted from this irreproducible feature, for example by measuring the channel bit length at a plurality of fixed sampling positions.

It is observed that WO 02/067255 A1 describes record carrier having recorded a primary signal having variable bit length, where a secondary signal is embedded in the primary signal, encoded in variations of the bit length. However in this case the variations of the bit length carry a predetermined information and therefore are controlled, whereas, in the case of the present invention the variations in the channel bit length are the result of an uncontrollable and substantially random process, and therefore do not carry any predetermined information.

As it will be clear from the foregoing discussion, the second object is achieved, according to the invention, by a method of extracting fingerprint data as claimed in claim 2, and by an apparatus for extracting fingerprint data as claimed in claim 12. Similarly, the third object is achieved by a record carrier as claimed in claim 14.

Various advantageous embodiments are claimed in the dependent claims.

These and other aspects of the methods and apparatuses according to the invention will be further elucidated and described with reference to the drawings. In the drawings:

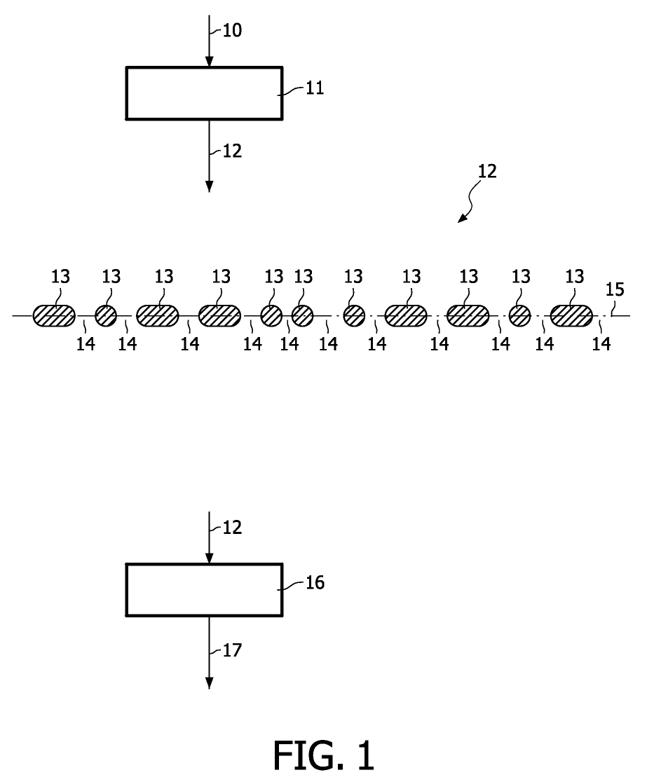

FIG. 1 shows a schematic diagram of a known method of recording data, a corresponding recorded pattern, and a known method of extracting fingerprint data,

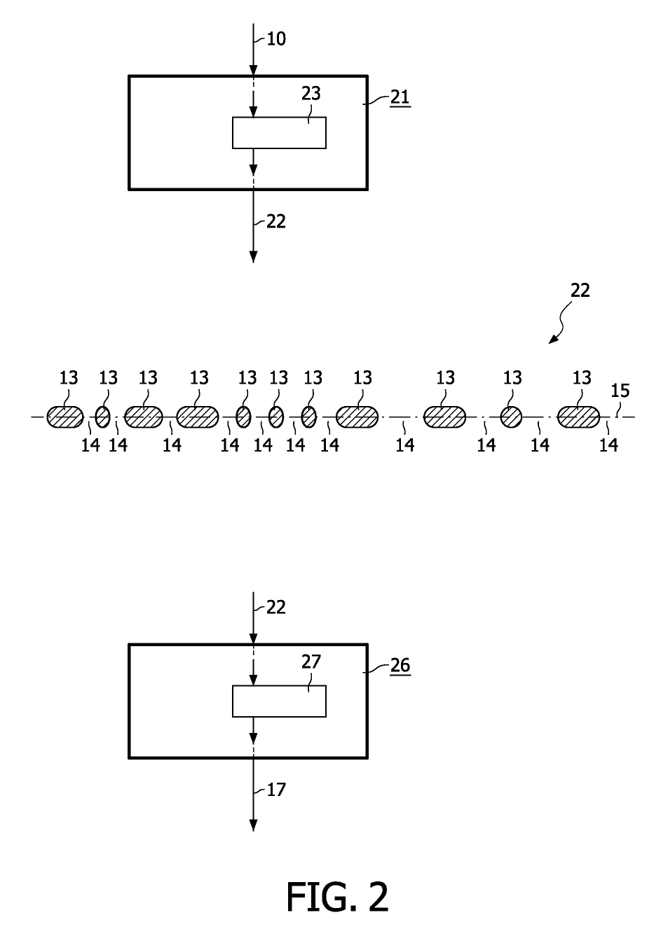

FIG. 2 shows a schematic diagram of a method of recording data, a corresponding recorded pattern, and method of extracting fingerprint data according to the invention,

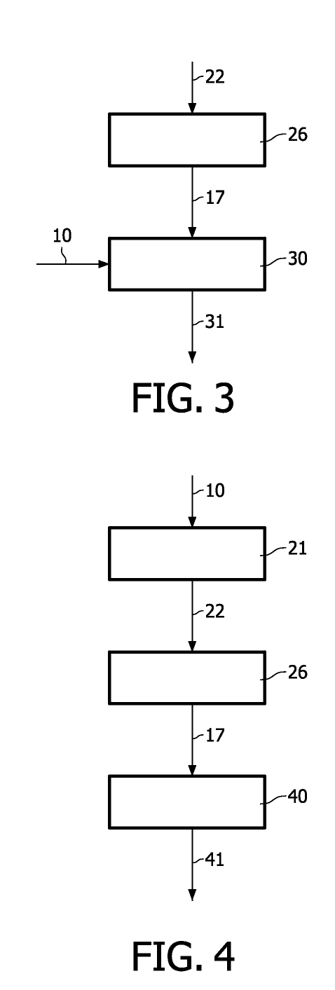

FIG. 3 shows an embodiment of the method of extracting fingerprint according the invention,

FIG. 4 shows an embodiment of a recording process according to the invention,

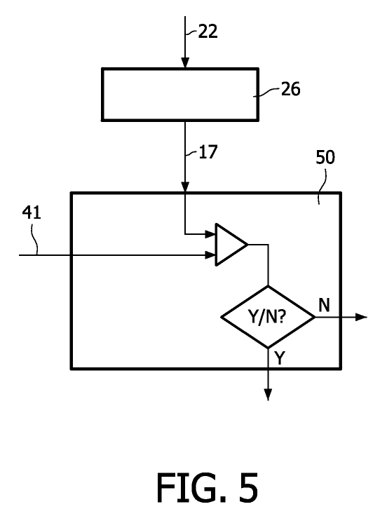

FIG. 5 shows a schematic diagram of a method of authentication making use of the invention,

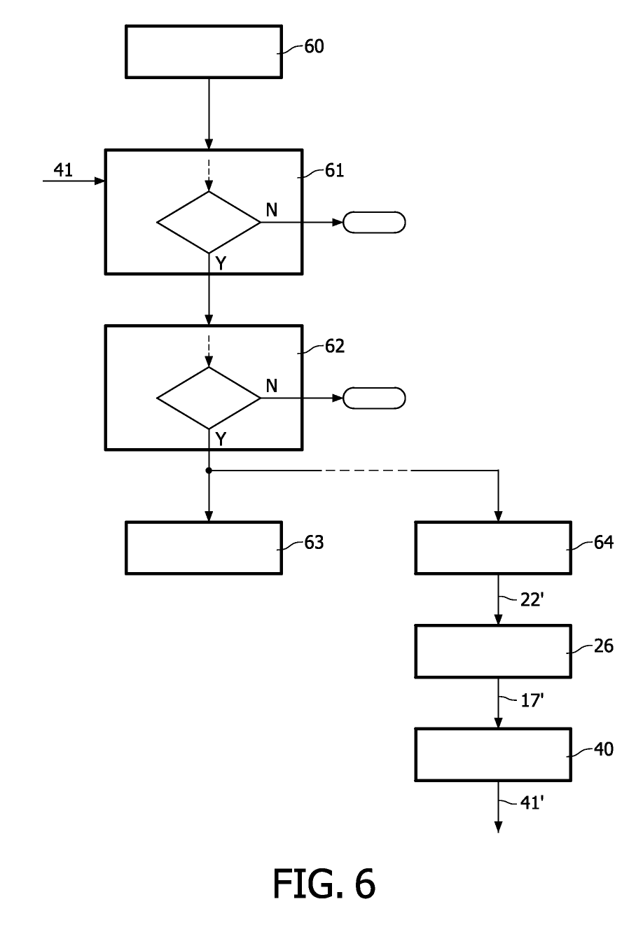

FIG. 6 shows a method of accessing a record carrier where DRM data are protected using the invention,

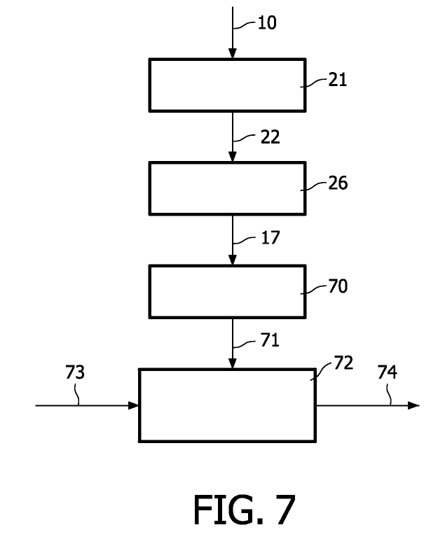

FIG. 7 shows an alternative method of protecting data recorded on a record carrier making use of the invention,

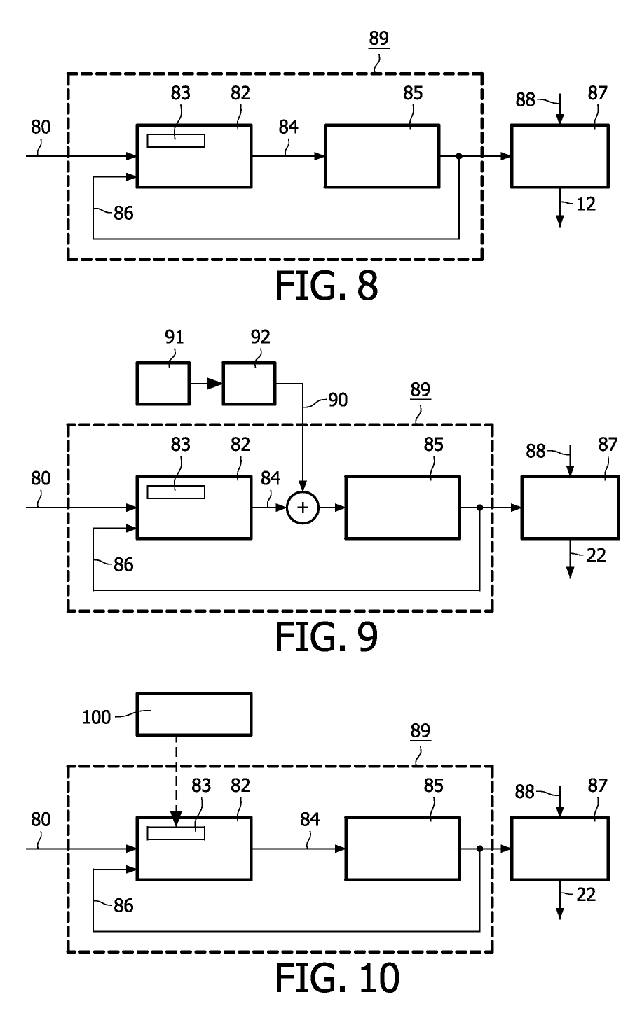

FIG. 8 shows a schematic diagram of a known apparatus for recording data,

FIG. 9 shows an embodiment of an apparatus for recording data according to the invention,

FIG. 10 shows a further embodiment of an apparatus for recording data according to the invention.

FIG. 1 shows a schematic diagram of a known method of recording data, a corresponding recorded pattern, and a known method of extracting fingerprint data. Data 10 are the input of a recording process 11, by which a recorded pattern 12 is formed on a record carrier. The recorded pattern 12 consists of a sequence of first areas 13, interleaved by second areas 14, distinguishable from the first areas 13 on the basis of a relevant physical parameter like for example reflectivity, state of magnetization, or electrical charge. The first areas 13 and the second areas 14 are present along a recording track 15, and correspond respectively to the logical values 1 and 0, or vice-versa, according to which of the two conventions is adopted. In practice the recorded pattern 12 is formed by selectively forcing a change in the relevant physical parameter, e.g. by supplying thermal power, a magnetic field or a voltage. The first areas 13 and the second areas 14 have lengths corresponding to multiples of a length unit, i.e. the length of a channel bit, which is substantially constant for the entire recorded pattern 12.

Generally, the recorded pattern 12 has to respect some standard specifications given for the relevant type of record carrier, like for instance affecting the width or length of the areas, the steepness of the transition from a first area to a second area and vice-versa, etc. In spite of these standard specifications to which any recorded pattern has to adhere, it is possible to define some properties according to which a recorded pattern is highly likely to be different from any other recorded pattern, similarly to a person's fingerprint. These properties, can for example refer to:
one or more parameters for which there is no standard specification, or
one or more parameters for which there is a standard specification, but observed at a level of resolution higher than the one used in the standard specification. These properties can be used as distinctive feature or “fingerprint” of the recorded pattern 12 in a fingerprint extraction process 16 to extract fingerprint data 17, as known from the above-mentioned non-prepublished EP application No. 04106504.6.

The data 10 can be retrieved from the recorded pattern 12 by generating a read-out signal, depending on the relevant physical parameter, while scanning the recording track 15. A channel bit clock signal, which can be recovered from the read-out signal, can be used for sampling the read-out signal, thereby allowing retrieval of the data 10.

FIG. 2 shows a schematic diagram of a method of recording data, a recorded pattern, and a corresponding method of extracting fingerprint data according to the invention. The recording process 21 is different from the known recording process 11 in that it comprises a perturbation step 23 for imposing an uncontrollable perturbation in controlling the channel bit length, so as to cause the recorded pattern 22 which is formed on the record carrier, to have a variable channel bit length. In the Fig. it is possible to see that the first areas 13 and the second areas 14 are relatively shorter and close to one another in a part of the recorded pattern 22, and relatively longer and more distant from one another in another part of the recorded pattern 22. The dimensions shown in the Fig. are chosen merely for comprehension purposes and do not realistically reflect e.g. the proportions involved between the size of first areas 13 and second areas 14, and the entity or speed of the variation in the channel bit length.

The channel bit length shall still remain within the boundaries of a maximum/minimum length, if any such specification is given. The overall trend of the channel bit length can thus be used as “fingerprint” of the recorded pattern 22 in a corresponding fingerprint extraction process 26, where the fingerprint data 17 are derived in a step of determining the fingerprint data from the channel bit length of the recorded pattern 22. The fingerprint data 17 may consist for example of a collection of samples of the channel bit length, measured at predetermined sampling points. These predetermined sampling points may be determined upon a timing and/or synchronization information present in the recording track 15, like in the case of recordable optical discs, where timing and/or synchronization information are present in the recording track 15 in the form of wobble frequency of the track and/or information encoded therein.

The channel bit length, can be measured my measuring the channel bit frequency of the channel bit clock which is recovered from the read-out signal by means of a PLL. The frequency ofthe recovered channel bit clock is generally available: for example an output of the integrator, which is part of the PLL loop filter, can be used to observe variations in the recovered channel bit clock. In this way only the component of the variations of the channel bit length, introduced while recording, that lies within the bandwidth of the PLL (during readout) can be observed. Unfortunately there are noise sources that can give rise to variations in the recovered channel bit clock. In reference to a rotatable disc for example, the dominant noise source here is eccentricity. However, due to its periodic nature, the variations in the recovered channel bit clock due to eccentricity can be removed.

If a synchronization information is present in the recording track 15, the channel bit length can be calculated by counting the periods of the recovered channel bit clock during intervals of equal length, the intervals of equal length being defined on the basis of said synchronization information. In a recordable optical disc, where a wobble is present, it is possible to count the number of channel bits present in different wobble periods. An advantage of this method is that variations due to eccentricity do not affect the measurement. The reason is that eccentricity influences the wobble frequency in the same way as it affects the frequency ofthe recovered channel bit clock. It is in a way a relative measurement.

The method of extracting fingerprint data shown in FIG. 2 can be enhanced, as shown in FIG. 3, by a subsequent authentication data derivation step 30 in which authentication data 31 are generated upon the fingerprint data 17; in particular, the authentication data 31 may be generated in dependence of the data 10 as well. A one-way function like for example a hash function or a cryptographic summary is suitable for use in this authentication data derivation step 30.

FIG. 4 shows an embodiment of a method of recording data according to the invention. The recorded pattern 22 created with the recording process 21 is used in a subsequent fingerprint extraction process 16 to extract fingerprint data 17. These fingerprint data 17 are then stored in a storing step 40 as reference fingerprint data 41 for subsequent use for authentication of the data 10. In particular the reference fingerprint data 41 may be recorded as well on the record carrier.

The reference fingerprint data 41 can be subsequently used in a method of authentication, like schematically shown in FIG. 5, which aim is to establish if data 10 recorded on the record carrier in the form of the recorded pattern 22 have been manipulated, possibly against the intention of a party involved, for example an owner of the data 10 or an authority which controls the content of the data 10. In this method fingerprint data 17, extracted from the recorded pattern 22 in the fingerprint extraction process 26, are checked for consistency with the reference fingerprint data 41 in a consistency checking step 50. The method continues for example with allowing use or full access to the data 10 if these are confirmed to be authentic. This method relies on the fact that data 10 recorded on the record carrier may easily be overrecorded, but there is at least a technical barrier to overcome in updating the reference fingerprint data 41. Therefore, while the data 10 can easily have been manipulated, the reference fingerprint data 41, which derive from the original data 10 cannot, so that by checking the consistency of the reference fingerprint data 41 and the fingerprint data 17 extracted from the recorded pattern 22 it can be established if the data 10 are original or not.

The method can be enhanced by use of a helper data, by use of which the comparison is done on those parts of the fingerprint data 17 that are more reliably consistent at each instance of the fingerprint extraction step 26.

Clearly, if the method of extracting fingerprint data comprises an authentication data derivation step 30 as shown in FIG. 3, the consistency checking step 50 must be intended as involving the authentication data 31 and reference authentication data.

FIG. 6 shows a method of accessing a record carrier where DRM data are protected using the invention. In this embodiment a record carrier is accessed wherein are recorded a Digital Work (DW), like for example a film which is subject to copyright, and Digital Rights Management (DRM) information, specifying the extent and the conditions under which the DW can be exploited. The DRM information may comprise a condition like for example view max. 3 times, view for one month, copy once, etc. In order to prevent that the original DRM information is replaced by a malicious user by other DRM information specifying conditions which are less restrictive than those specified in the original DRM information, the original DRM information is protected by recording the DRM information as the data 10 with a method of recording according to the invention, and by having stored reference fingerprint data 41, extracted according to the invention from the recorded pattern 22 corresponding to the DRM information, for subsequent authentication. Therefore the method starts with a DRM accessing step 60, for accessing the recorded pattern 22 corresponding to the DRM information. Subsequently, the DRM information is authenticated in authentication step 61, with a method as described in FIG. 5; if the authentication step 61 is not successful the method is terminated, otherwise the method continues with a DRM checking step 62, in which it is verified if the DRM information, which at this point is considered to be authentic, allows access to the DW. If the access to the DW is not allowed the method is terminated, otherwise the method continues with a DW accessing step 63. Since the DRM information may require some updating, like in the case in which a number of accesses available is specified and therefore such number has to be decremented, the method may continue with a DRM updating step 64, in which the DRM information is updated, and the DRM information originally recorded on the record carrier is overrecorded with the updated DRM information with a method of recording according to the invention, thereby creating a new recorded pattern 22′. Subsequently a new fingerprint data 17′ is extracted from the new recorded pattern 22′ in the fingerprint data extraction step 26 and the new fingerprint data 17′ is stored in the storing step 40 as new reference fingerprint data 41′ for authentication during a subsequent instance of this method of accessing the record carrier. The DRM updating step 64, the fingerprint data extraction step 26 and the storing step 40, should take place indissolubly together with the DW accessing step 63.

The invention can also be exploited in an alternative method of protecting data recorded on a record carrier as shown in FIG. 7. According to this method the fingerprint data 17 are used in a key extraction step 70 to derive an encryption key 71, which is then used in an encryption step 72 to encrypt the DW 73, thereby obtaining and encrypted DW 74. The data 10 may be random data having the sole purpose of being used for generating the recorded pattern 22, however any auxiliary data, for example the DRM information, could be used as the data 10. In the key extraction step 70 preferably a one-way function is used to obtain the encryption key 71 from the fingerprint data 17. However, since the fingerprint data extraction step 26 has inherently the nature of a one-way function, the fingerprint data 17 can be used directly as encryption key 71, clearly subject to considerations on the size of the fingerprint data 17.

FIG. 8 shows a schematic diagram of a known apparatus for recording data on a record carrier. The apparatus comprises recording means 87 for forming the recorded pattern 12 on the record carrier by selectively modifying a relevant physical parameter along the recording track 15. The recording means 87 have two inputs:
an input for receiving a sequence of channel bits 88, i.e. the encoded version of the data 10, encoded according to some encoding rule, to be recorded on the record carrier, and
an input for receiving a channel bit clock 86, which controls the time at which the recording means 87 start/stop modifying the relevant physical parameter along the recording track 15.

The channel bit clock 86 is provided by synchronization means 89, i.e. a clock control loop, also known as PLL. Within this clock control loop, the channel bit clock 86 is generated by a clock generator 85, and compared with a reference synchronization signal 80 inside a controller 82, operating according to some control parameters 83, which generates a control signal 84, controlling the clock generator 85 to increase/decrease the rate of the channel bit clock 86, according to what is necessary to bring in phase the reference synchronization signal 80 and the channel bit clock 86.

In reference with an apparatus for recording data on a recordable optical disc, the recording means 87 comprise a laser which supplies via a radiation beam a thermal energy sufficient for changing the reflectivity of an area subjected to the radiation beam. The reference synchronization signal 80 is a synchronization signal recovered from the wobble modulation of the recording track 15, and reflects the speed at which the recording track is scanned. Clearly in this case, before comparing the channel bit clock 86 and the reference synchronization signal 80, one of these two signals must be scaled by a scaling factor reflecting the desired relation between these two signals. Therefore the synchronization means 89 effectively control the channel bit length in the recorded pattern.

FIG. 9 shows how the control loop shown in FIG. 8 is modified in an embodiment of an apparatus according to the invention. In order to generate a variable length of a bit clock a disturbance 90 is added to the control signal 84. This disturbance 90 can be generated by use of a noise generator 91, particularly a white noise generator; a Band Pass filter 92 for spectrally shaping the noise may also be present.

An alternative embodiment of the apparatus according to the invention is shown in FIG. 10. In this case the perturbation in the synchronization means is caused by altering the control parameters 83 of the controller 82 with a control parameters alteration unit 100. This manipulation effected may comprise any combination of the following:
deliberately using non optimal values for the control parameters 83,
temporarily changing the value of the control parameters 83, and
adding to the value of the control parameters 83 a variable component pseudo-randomly generated.

In both the embodiments shown in FIG. 9 and FIG. 10 what is achieved is that the channel bit length, or longitudinal density of the recorded pattern 22, will not be substantially constant, but will show some variations. The exact value of the channel bit length at a given point however is not subject to control. Consequently the overall trend of the channel bit length can be seen as the result of an uncontrolled and irreproducible process.

Clearly, the various measures described have to be designed so that the resulting recorded pattern 22 is compliant with the specifications of the relevant standard, for example regarding the average channel bit length and its maximum deviation from a nominal value, if any such specifications are given. Moreover, preferably, the resulting variations in the channel bit length should have a spectral extension within the bandwidth of a channel bit clock recovery unit, which is used for recovering the channel bit clock from the read-out signal, so as not to hamper retrieval of the data 10. Subject to this considerations however, preferably, the resulting variations in the channel bit length are rather fast and with high frequency components, so as to render more difficult any attempt to form a recorded pattern 22 having a desired fingerprint.

Although the invention has been elucidated with reference to an optical record carrier, it will be evident that other applications are possible, for example to a rotatable non optical record carrier. The scope of the invention is therefore not limited to the embodiments described above.

It must further be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. In the field of content distribution a typical problem is the protection of Digital Rights information (DRM), which is appended to the content and recorded on a record carrier in the form of a corresponding recorded pattern, from tampering by malicious users. According to some known schemes, the protection is implemented by linking the DRM to some physical distinctive feature of the corresponding recorded pattern. From this distinctive feature fingerprint data can be extracted with some conventional method, and used for the authentication of the DRM. The invention proposes a method of recording data wherein variations in the density of the recorded pattern are formed, as result of a perturbation imposed in the recording process, which perturbation is a non-controllable substantially random process.

1. Method of recording data (10) on a record carrier along a recording track (15), comprising:
recording the data, thereby forming a recorded pattern (22) having a channel bit length, and
controlling the channel bit length, further comprising
imposing an uncontrollable perturbation in controlling the channel bit length, so as to cause the recorded pattern to have variations in the channel bit length.

2. Method of extracting fingerprint data from data (10) recorded on a record carrier along a recording track (15) in the form of a recorded pattern (22) wherein
the fingerprint data (17) are determined upon variations in the channel bit length of the recorded pattern (22), the variations in the channel bit length being a distinctive feature of the recorded pattern.

3. Method of extracting fingerprint data as claimed in claim 2, further comprising generating authentication data (31) upon the fingerprint data (17).

4. Method of extracting fingerprint data as claimed in claim 3, wherein the authentication data (31) are generated upon the fingerprint data (17) in dependence of the data (10).

5. Method of recording data (10) on a record carrier along a recording track (15), comprising:
recording the data, thereby forming a recorded pattern (22) having a channel bit length, and
controlling the channel bit length, further comprising
imposing an uncontrollable perturbation in controlling the channel bit length, so as to cause the recorded pattern to have variations in the channel bit length, further comprising:
applying the method of claim 2 for extracting fingerprint data (17) from the data (10) recorded on the record carrier,
storing the fingerprint data (17) as reference fingerprint data (41) for subsequent authentication of the data (10).

6. Method as claimed in claim 5, wherein the reference fingerprint data (41) are stored in the record carrier.

7. Method of authenticating data (10) recorded on a record carrier along a recording track (15) in the form of a recorded pattern (22), from which recorded pattern fingerprint data (17) can be extracted, reference fingerprint data (41) being available for authentication purposes, the method comprising:
extracting the fingerprint data (17),
acquiring the reference fingerprint data (41),
checking if the fingerprint data are consistent with the reference fingerprint data,
wherein
the recorded pattern (22) has variations in channel bit length, the variations in the channel bit length being a distinctive feature of the recorded pattern, and in extracting the fingerprint data the method of claim 2 is used.

8. Apparatus for recording data (10) on a record carrier along a recording track (15), comprising:
recording means for recording the data, thereby forming a recorded pattern (22) having a channel bit length, and
synchronization means (89) for controlling the channel bit length, further comprising perturbation means are present for imposing an uncontrollable perturbation to the synchronization means, so as to cause the recorded pattern to have variations in the channel bit length.

9. Apparatus as claimed in claim 8, wherein the synchronization means (89) comprise a clock generator (85) for generating a channel bit clock (86), and a controller (82), operating according to some control parameters (83), for providing a control signal (84) to the clock generator, on the basis of the channel bit clock and of a reference synchronization signal (80).

10. Apparatus as claimed in claim 9, wherein the perturbation means comprise an adder for adding a noise (90) to the control signal (84).

11. Apparatus as claimed in claim 9, wherein the perturbation means comprise an alteration unit (100) for altering the control parameters (83) in the controller (82).

12. Apparatus for extracting fingerprint data from data (10) recorded on a record carrier along a recording track (15) in the form of a recorded pattern (22),
configured for determining the fingerprint data (17) upon variations in the channel bit length of the recorded pattern (22), the variations in the channel bit length being a distinctive feature of the recorded pattern.

13. Apparatus as claimed in claim 8, being integral with an apparatus for extracting fingerprint data from data (10) recorded on a record carrier along a recording track (15) in the form of a recorded pattern (22),
configured for determining the fingerprint data (17) upon variations il the channel bit length of the recorded pattern (22), the variations in the channel bit length being a distinctive feature of the recorded pattern.

14. Record carrier having recorded data (10) along a recording track (15), in the form of a recorded pattern (22) having variations in a channel bit length, the variations in the channel bit length being a distinctive feature of the recorded pattern.

15. Record carrier having recorded data (10) along a recording track (15) in the form of a recorded pattern (22) having variations in a channel bit length, the variations in the channel bit length being a distinctive feature of the recorded pattern, having stored reference fingerprint data (41), obtained as fingerprint data (17) extracted from the data (10) with the method of claim 2.
